(19) United States
(12) Patent Application Publication
(10) Pub. No.: US 2012/0069951 A1
(43) Pub. Date: Mar. 22, 2012

(54) TOMOGRAPHIC IMAGE DISPLAYING METHOD AND APPARATUS

(75) Inventor: Hiroyuki TOBA, Kanagawa (JP)

(73) Assignee: FUJIFILM CORPORATION, Tokyo (JP)

(21) Appl. No.: 13/234,724

(22) Filed: Sep. 16, 2011

(30) Foreign Application Priority Data
Sep. 17, 2010 (JP) 2010-208883

(51) Int. Cl. H05G 1/60

(52) U.S. Cl. 378/4

(57) ABSTRACT

Provided is a tomographic image displaying method and apparatus capable of displaying a plurality of tomographic images in an easily viewable manner and enabling viewers to immediately understand a region of interest or the like. A predetermined target tomographic image is specified among a plurality of tomographic images, a weighting factor is multiplied to each of the plurality of tomographic images, and the weighted tomographic images are added to thereby generate and display a combined tomographic image. The weighting factor multiplied to the specified target tomographic image is set so as to be larger than the weighting factors multiplied to at least one of the tomographic images other than the target tomographic image.

### BACKGROUND OF THE INVENTION

1. Field of the Invention

The invention relates to a tomographic image displaying method and apparatus for generating a plurality of tomographic images of a subject based on a plurality of radiological images acquired by radiographing the subject from a plurality of different radiographing directions by irradiating radioactive rays and displaying the plurality of generated tomographic images.

2. Description of the Related Art

In recent years, in radiography apparatuses, for observation of affected parts in more detail, tomosynthesis radiography has been proposed, which involves moving a radiation source to radiograph a subject from different radiographing directions by irradiation of radioactive rays and adding the plurality of radiological images acquired by the radiography to obtain a tomographic image in which a desired sectional plane is enhanced. In tomosynthesis radiography, depending on the properties of the radiographing apparatus or the tomographic images needed, a radiation source is moved in parallel to a radiological image detector or moved so as to draw a circular or elliptical arc to acquire a plurality of radiological images of a subject radiographed at different radiation angles, and these radiographed images are reconstructed to generate tomographic images.

When generating tomographic images with such tomosynthesis radiography, a tomographic image in which structures within a desired sectional plane is enhanced can be obtained by blurring and annihilating structures outside the desired sectional plane. Thus, the visibility of images of pulmonary nodules and microfractures which are hard to view due to overlapping structures can be improved.

Although the imaging principle is different from the tomosynthesis radiographing apparatus described above, a so-called CT (Computerized Tomography) radiographing apparatus has been proposed as an apparatus that similarly radiographs tomographic images of a subject.

The tomosynthesis radiographing apparatus and the CT radiographing apparatus described above can acquire a number of tomographic images of a subject and a large amount of diagnostic information can be acquired by observing the respective tomographic images.

### SUMMARY OF THE INVENTION

However, for example, when a number of these tomographic images are displayed in a list view, there is a problem in that it is not easy to view the tomographic images. To solve this problem, JP2008-68032A, for example, has proposed a technique of applying weights to a number of tomographic images to generate an average image in which the weighted tomographic images are projected onto one projection plane.

However, although JP2008-68032A describes the acquisition of an average image as described above, there is no description of or suggestion as to how the respective tomographic images are weighted. Moreover, it is difficult to immediately understand a region of interest or the like on the average image.

The present invention has been made in view of the above-mentioned problems and an object of the present invention is to provide a tomographic image displaying method and apparatus capable of displaying a plurality of tomographic images acquired by the tomosynthesis radiographing apparatus and the CT radiographing apparatus described above in an easily viewable manner and enabling viewers to immediately understand a region of interest or the like.

According to an aspect of the present invention, a tomographic image displaying method includes: irradiating a subject with radioactive rays from a plurality of different radiographing directions; acquiring a radiological image for each of the radiographing directions, detected by a radiological image detector with the irradiation of radioactive rays; generating a plurality of tomographic images of the subject based on a plurality of acquired radiological images; and displaying the plurality of generated tomographic images, the method further including: specifying a predetermined target tomographic image among the plurality of tomographic images; multiplying a weighting factor to each of the plurality of tomographic images and adding the plurality of tomographic images multiplied by the weighting factors to thereby generate a combined tomographic image; and displaying the generated combined tomographic image, wherein a weighting factor multiplied to the specified target tomographic image is set so as to be larger than a weighting factor multiplied to at least one tomographic image other than the target tomographic image.

According to another aspect of the present invention, a tomographic image displaying apparatus includes: a radiological image acquisition unit that irradiates a subject with radioactive rays from a plurality of different radiographing directions to acquire a radiological image for each of the radiographing directions, detected by a radiological image detector with the irradiation of radioactive rays; a tomographic image generation unit that generates a plurality of tomographic images of the subject based on a plurality of radiological images acquired by the radiological image acquisition unit; and a display unit that displays the plurality of tomographic images generated by the tomographic image generation unit, the apparatus further including: a combined tomographic image generation unit that multiplies a weighting factor to each of the plurality of tomographic images generated by the tomographic image generation unit and adds the plurality of tomographic images multiplied by the weighting factors to thereby generate a combined tomographic image; and a target tomographic image specifying unit that specifies a predetermined target tomographic image among the plurality of tomographic images, wherein the combined tomographic image generation unit sets a weighting factor of the target tomographic image specified by the target tomographic image specifying unit so as to be larger than a weighting factor of at least one tomographic image other than the target tomographic image, and the display unit displays the combined tomographic image generated by the combined tomographic image generation unit.

In the tomographic image displaying apparatus of the above aspect of the present invention, the combined tomographic image generation unit may set the weighting factor of the target tomographic image to the largest value.

Moreover, the combined tomographic image generation unit may set weighting factors of tomographic images front and behind the target tomographic image so as to be smaller than that of the target tomographic image and larger than the weighting factors of tomographic images other than the tomographic images front and behind the target tomographic image.

Moreover, the combined tomographic image generation unit may multiply a weighting factor to tomographic images other than the target tomographic image and the tomographic images front and behind the target tomographic image according to the depths of the tomographic images.

Moreover, the combined tomographic image generation unit may set the weighting factors of the target tomographic image and tomographic images on the deeper side of the target tomographic image so as to be larger than the weighting factors of the other tomographic images.

Moreover, the combined tomographic image generation unit may set the weighting factors of the target tomographic image and tomographic images on the front side of the target tomographic image so as to be larger than the weighting factors of the other tomographic images.

Moreover, the combined tomographic image generation unit may set the weighting factors of tomographic images other than the target tomographic image to zero.

Moreover, the combined tomographic image generation unit may accumulatively change the weighting factors of the plurality of tomographic images to zero sequentially starting from the frontmost tomographic image to thereby generate a plurality of combined tomographic images in which a predetermined tomographic image on the deeper side of the frontmost tomographic image appears on the frontmost surface.

According to the tomographic image displaying method and apparatus according to the above aspects of the present invention, a predetermined target tomographic image is specified among the plurality of tomographic images, and a weighting factor is multiplied to each of the plurality of tomographic images and adding the plurality of tomographic images multiplied by the weighting factors to thereby generate and display a combined tomographic image so that a weighting factor multiplied to the specified target tomographic image is set so as to be larger than a weighting factor multiplied to at least one tomographic image other than the target tomographic image. Therefore, the combined tomographic images can be displayed in an easily viewable manner, and the target tomographic image of particular interest can be displayed more emphatically. Thus, viewers can understand a region of interest or the like included in the target tomographic image immediately.

Moreover, when the weighting factors of tomographic images front and behind the target tomographic image are set so as to be smaller than that of the target tomographic image and larger than the weighting factors of tomographic images other than the tomographic images front and behind the target tomographic image, an image near the target tomographic image can be displayed even more emphatically.

Furthermore, when the weighting factors of the target tomographic image and tomographic images on the deeper side of the target tomographic image are set so as to be larger than the weighting factors of the other tomographic images, or the weighting factors of the target tomographic image and tomographic images on the front side of the target tomographic image are set so as to be larger than the weighting factors of the other tomographic images, the relationship between the target tomographic image and the tomographic image on the deeper side thereof and the relationship between the target tomographic image and the tomographic image on the front side thereof can be understood. Thus, a larger amount of diagnostic information can be acquired.

Furthermore, when the weighting factors of the plurality of tomographic images are accumulatively changed to zero sequentially starting from the frontmost tomographic image to thereby generate a plurality of combined tomographic images in which a predetermined tomographic image on the deeper side of the frontmost tomographic image appears on the frontmost surface, by successively displaying the plurality of combined tomographic images in a switched manner, for example, the combined tomographic images can be observed while enabling viewers to understand the spatial distribution of a region of interest such as calcification.

### BRIEF DESCRIPTION OF THE DRAWINGS

FIG. 1 is a schematic configuration view of a breast image radiographing and displaying system using an embodiment of a tomographic image displaying apparatus according to the present invention.

FIG. 2 is a view of an arm unit of the breast image radiographing and displaying system shown in FIG. 1 as viewed from the right side of FIG. 1.

FIG. 3 is a block diagram showing a simplified internal configuration of a computer of the breast image radiographing and displaying system shown in FIG. 1.

FIG. 4 is a view showing a displacement of the position of a radiation source and an irradiation point of radioactive rays from the start to the end of radiographing in the breast image radiographing and displaying system shown in FIG. 1.

FIG. 5 is a view illustrating a method of reconstructing tomographic images based on a plurality of radiological images.

FIG. 6 is a view illustrating weighting factors multiplied to a plurality of tomographic images.

FIG. 7 is a view illustrating a method of accumulatively changing the weighting factors of a plurality of tomographic images to zero, starting sequentially from the frontmost tomographic image.

FIG. 8 is a view illustrating a method of increasing the weighting factors of a plurality of tomographic images sequentially from the frontmost tomographic image.

FIG. 9 is a schematic configuration view of a radiological image radiographing and displaying system for general radiography using an embodiment of the tomographic image displaying apparatus according to the present invention.

FIG. 10 is a view illustrating a method of putting colors on each tissue in a combined tomographic image.

### DESCRIPTION OF THE PREFERRED EMBODIMENTS

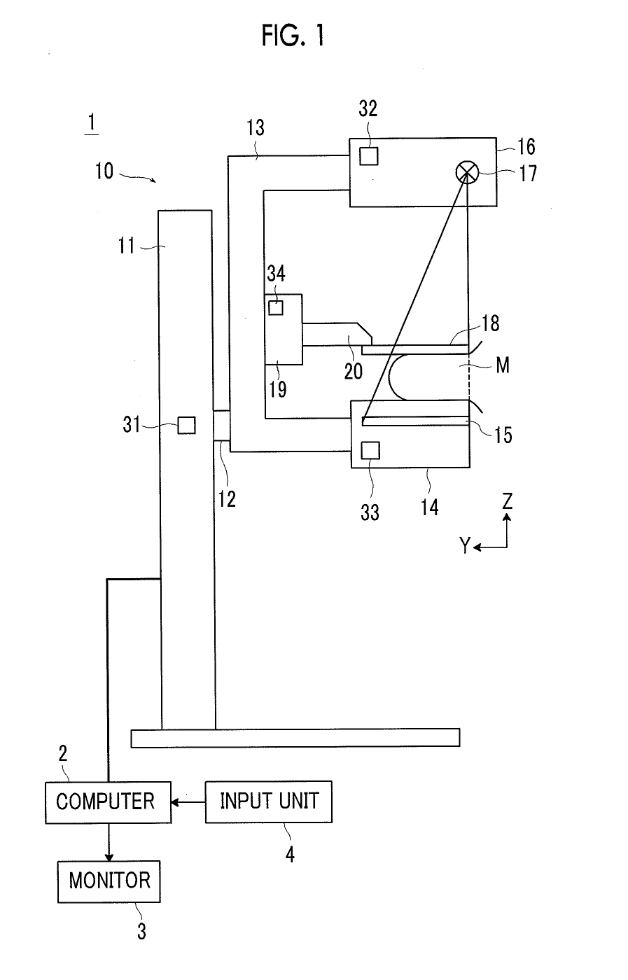

Hereinafter, a breast image radiographing and displaying system using an embodiment of a tomographic image displaying apparatus of the present invention will be described with reference to the accompanying drawings. The breast image radiographing and displaying system of this embodiment has a tomosynthesis imaging function and is configured to be capable of radiographing tomographic images of a breast. Although the breast image radiographing and displaying system of this embodiment is characterized by a method of displaying tomographic images, first, an overall configuration of the system will be described. FIG. 1 is a view showing a simplified overall configuration of the breast image radiographing and displaying system according to this embodiment.

As shown in FIG. 1, the breast image radiographing and displaying system 1 of this embodiment includes a breast image radiographing apparatus 10 that irradiates radioactive rays toward a breast which is a subject from different radiographing directions to acquire a plurality of radiological images of the breast, a computer 2 that reconstructs the plurality of radiological images acquired by the breast image radiographing apparatus 10 to generate a tomographic image of the breast, a monitor 3 that displays the tomographic image generated by the computer 2, and an input unit 4.

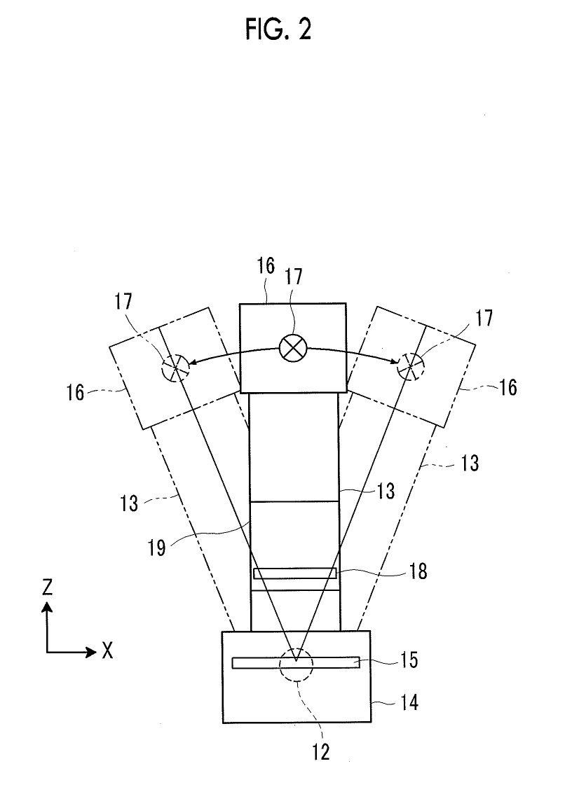

As shown in FIG. 1, the breast image radiographing apparatus 10 includes a base 11, a rotation shaft 12 that is movable in the vertical direction (Z direction) and rotatable with respect to the base 11, and an arm unit 13 that is connected to the base 11 by the rotation shaft 12. FIG. 2 shows the arm unit 13 as viewed from the right side of FIG. 1.

The arm unit 13 has a C-shape and includes one end to which a radiography platform 14 is attached and the other end to which a radiation irradiation unit 16 is attached so as to face the radiography platform 14. The rotation and vertical movement of the arm unit 13 are controlled by an arm controller 31 that is incorporated into the base 11.

The radiography platform 14 includes a radiological image detector 15 such as a flat panel detector, and a detector controller 33 that controls the reading of a charge signal from the radiological image detector 15.

Moreover, the radiography platform 14 includes, for example, a circuit board on which a charge amplifier that converts the charge signal read from the radiological image detector 15 into a voltage signal, a correlated double sampling circuit that samples the voltage signal output from the charge amplifier, and an A/D conversion unit that converts the voltage signal into a digital signal are formed.

As shown in FIG. 2, the radiography platform 14 is attached to the arm unit 13 such that the center of the radiological image detector 15 is located on an extension line of the rotation shaft 12. Moreover, the radiography platform 14 is configured so as to be rotatable with respect to the arm unit 13. Therefore, even when the arm unit 13 is rotated with respect to the base 11, the direction of the radiography platform 14 can be fixed with respect to the base 11.

The radiological image detector 15 can repeatedly record and read the radiological image and may be a so-called direct radiological image detector that directly receives irradiation of radioactive rays to generate charge or a so-called indirect radiological image detector that converts radioactive rays into visible light and then converts the visible light into a charge signal. As a method of reading a radiological image signal, it is preferable to use a so-called TFT reading method of turning on or off a TFT (thin film transistor) switch to read the radiological image signal or a so-called optical reading method of emitting reading light to read the radiological image signal. However, the reading method is not limited thereto, and other methods may be used.

The radiation irradiation unit 16 includes a radiation source 17 and a radiation source controller 32. The radiation source controller 32 controls the time when radioactive rays are irradiated from the radiation source 17 and the radiation generation conditions (for example, a tube current, time, and a tube current-time product) of the radiation source 17.

In addition, a compression plate 18 that is provided above the radiography platform 14 and compresses the breast, a supporting portion 20 that supports the compression plate 18, and a moving mechanism 19 that moves the supporting portion 20 in the vertical direction (Z direction) are provided at the center of the arm unit 13. The position and compression pressure of the compression plate 18 are controlled by a compression plate controller 34.

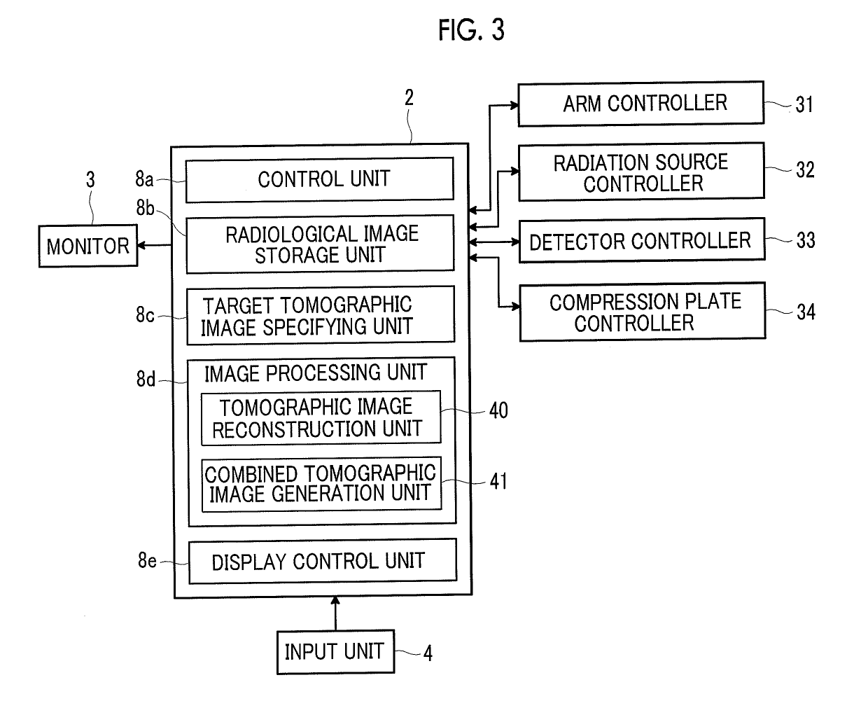

The computer 2 includes, for example, a central processing unit (CPU) and a storage device, such as a semiconductor memory, a hard disk, or an SSD. A control unit 8a, a radiological image storage unit 8b, a target tomographic image specifying unit 8c, an image processing unit 8d, and a display control unit 8e shown in FIG. 3 are formed by these hardware components.

The control unit 8a outputs predetermined control signals to various kinds of controllers 31 to 34 to control the entire system. A detailed control method will be described later.

The radiological image storage unit 8b stores a plurality of radiological image signals detected by the radiological image detector 15 in advance by radiographing from different radiographing directions.

The target tomographic image specifying unit 8c specifies a tomographic image including the tomographic image of calcification as a target tomographic image among a plurality of tomographic images generated by a tomographic image reconstruction unit 40 of the image processing unit 8d described later and outputs the information on the target tomographic image to a combined tomographic image generation unit 41 of the image processing unit 8d described later. As a method of detecting calcification, a morphology filter process or the like may be used, for example. Moreover, in this embodiment, a tomographic image including the tomographic image of calcification is specified as a target tomographic image. However, the specifying method is not limited to this, and a tomographic image including an abnormal shadow may be specified as the target tomographic image. For example, when specifying a tomographic image including the tomographic image of a tumor mass as the target tomographic image, the tumor mass may be detected using an iris filter process or the like.

In this embodiment, although the target tomographic image is automatically specified by the target tomographic image specifying unit 8c, it may not necessarily be performed automatically. For example, an operator such as a physician may designate an arbitrary tomographic image as the target tomographic image using the input unit 4 among the plurality of tomographic images generated by the tomographic image reconstruction unit 40, and the target tomographic image specifying unit 8c may specify the target tomographic image by reading information on the designated tomographic image.

The image processing unit 8d includes the tomographic image reconstruction unit 40 and a combined tomographic image generation unit 41.

The tomographic image reconstruction unit 40 reads a plurality of radiological image signals stored in the radiological image storage unit 8b and reconstructs a tomographic image of a desired sectional plane of a breast M using the plurality of radiological image signals. A detailed method of reconstructing the tomographic image will be described later.

The combined tomographic image generation unit 41 applies a weighting factor to each tomographic image signal of a plurality of sectional planes of the breast M generated by the tomographic image reconstruction unit 40 and adds the weighted tomographic image signals to thereby generate a combined tomographic image. Moreover, the combined tomographic image generation unit 41 of this embodiment increases a weighting factor of the target tomographic image specified by the target tomographic image specifying unit 8c so as to be larger than a weighting factor of a tomographic image other than the target tomographic image. A detailed method of generating the combined tomographic image will be described later.

The display control unit 8e performs predetermined processing on the combined tomographic image signal generated by the combined tomographic image generation unit 41 and the tomographic image signal generated by the tomographic image reconstruction unit 40 and then displays a resulting image on the monitor 3.

The input unit 4 includes a keyboard or a pointing device, such as a mouse, and receives a designation of an arbitrary target tomographic image among the plurality of tomographic images of the breast M as described above an input of radiographing conditions, an input of a radiographing start instruction, and the like.

Next, the operation of the breast image radiographing and displaying system according to this embodiment will be described.

First, the breast M of a patient is placed on the radiography platform 14 and the compression plate 18 compresses the breast M with a predetermined pressure.

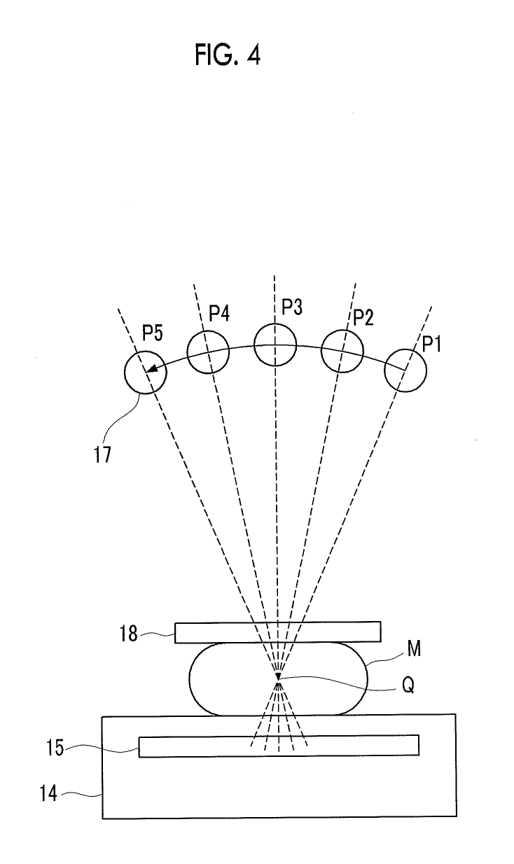

Then, the input unit 4 sequentially receives various kinds of radiographing conditions and an image start instruction from the radiographer. When the radiographing start instruction is input, the arm controller 31 rotates the arm unit 13. FIG. 4 is a view showing a displacement of the position of the radiation source 17 and an irradiation point Q of radioactive rays from the start to the end of radiographing.

Specifically, first, the arm controller 31 rotates the arm unit 13 so that the radiation source 17 is disposed at a position S1. The radiation source controller 32 controls the radiation source 17 based on the generation conditions for radioactive rays generated at the position S1 so that radioactive rays are irradiated toward an irradiation point Q. The irradiation point Q is preferably set to a point about 2 cm above the central position of the breast M when the breast M is placed on the upper surface of the radiography platform 14. In this way, a radiological image of the breast M is recorded by the radiological image detector 15 as a latent charge image.

Subsequently, the radiological image recorded on the radiological image detector 15 as the latent charge image is read under the control of a detector controller 55. Then, the read radiological image signal is input to the computer 2 and stored in the radiological image storage unit 8b.

After that, under the control of the respective controller, the radiation source 17 moves on a surface near the chest wall of a subject so as to draw a circular arc, and the radiological images of the breast are acquired at the respective positions Sn (in FIG. 4, n is 1 to 5) on the movement line and stored in the radiological image storage unit 8b. Although only five points of S1 to S5 are depicted in FIG. 4 for the sake of convenience, in actual radiography, about 10 to 20 radiological images are acquired within the range of about ±30° with respect to a direction vertical to the subject surface of the radiography platform 14.

Subsequently, n radiological image signals stored in the radiological image storage unit 8b in the above-described manner are output to the tomographic image reconstruction unit 40 of the image processing unit 8d. Then, the tomographic image reconstruction unit 40 reconstructs a tomographic image signal of an arbitrary sectional plane of the breast M using the input n radiological image signals. A method of reconstructing a tomographic image signal of an arbitrary sectional plane of the breast M will be described below.

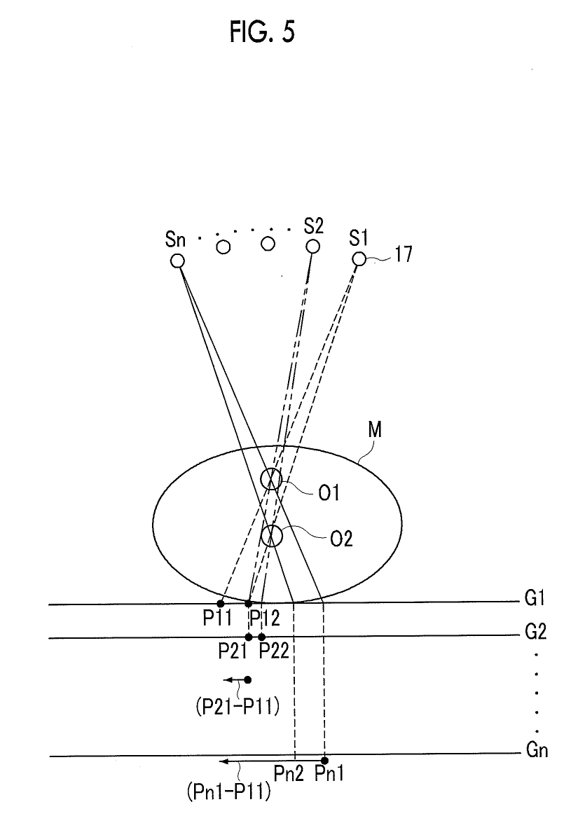

First, as shown in FIG. 5, the radiation source 17 is moved to the respective positions S1, S2, . . . , and Sn, radioactive rays are irradiated from the respective positions to the breast M to acquire radiological images G1, G2, . . . , and Gn, respectively.

Here, for example, when objects O1 and O2 present at different depths are projected from the position S1, the projection images thereof appear at positions P11 and P12 on the radiological image G1, respectively. Moreover, when the objects O1 and O2 are projected from the position S2, the projection images thereof appear at positions P21 and P22 on the radiological image G2, respectively. In this way, when the objects O1 and O2 are repeatedly projected from different source positions S1, S2, . . . , and Sn, the object O1 will be projected at positions P11, P21, and Pn1 and the object O2 will be projected at positions P12, P22, . . . , and Pn2 in correspondence to the respective source positions.

When it is desired to enhance a section on which the object O1 is present, the radiological images G2, G3, . . . , and Gn are moved by a distance of P21-P11, P31-P11, . . . , and Pn1-P11, respectively, and are added, whereby a tomographic image in which structures on a section at the same depth as the object O1 appear sharper is created.

Moreover, when it is desired to enhance a section on which the object O2 is present, the radiological images G2, G3, . . . , and Gn are moved by a distance of P22-P12, P32-P12, . . . , and Pn2-P12, respectively, and are added. In this way, by aligning the respective radiological images G1, G2, . . . , and Gn according to the position of a required section and adding the aligned radiological images, a tomographic image in which a desired sectional plane appears sharper can be acquired.

In the above-described manner, the tomographic image reconstruction unit 40 reconstructs tomographic image signals of a plurality of sectional planes set in advance.

The plurality of tomographic image signals generated by the tomographic image reconstruction unit 40 are output to the target tomographic image specifying unit 8c and the combined tomographic image generation unit 41. The target tomographic image specifying unit 8c performs a process of detecting calcification in the respective input tomographic image signals to specify a tomographic image signal including calcification and outputs information on the specified tomographic image signal to the combined tomographic image generation unit 41.

The combined tomographic image generation unit 41 applies a weighting factor to each of the input tomographic image signals and adds the weighted tomographic image signals to thereby generate a combined tomographic image signal. Specifically, for example, when six tomographic image signals A to F are input, the respective tomographic image signals A to F are multiplied by weighting factors n1 to n6, respectively, and the weighted tomographic image signals are added, whereby the combined tomographic image signal G is generated as shown in Expression (1) below.

Combined tomographic image signal G=(n1×A)+(n2×B)+(n3×C)+(n4×D)+(n5×E)+(n6×F) (1)

Here, when generating the combined tomographic image signal G as described above, the combined tomographic image generation unit 41 of this embodiment sets the weighting factor of the tomographic image signal specified by the target tomographic image specifying unit 8c so as to be larger than the weighting factors of the other tomographic image signals.

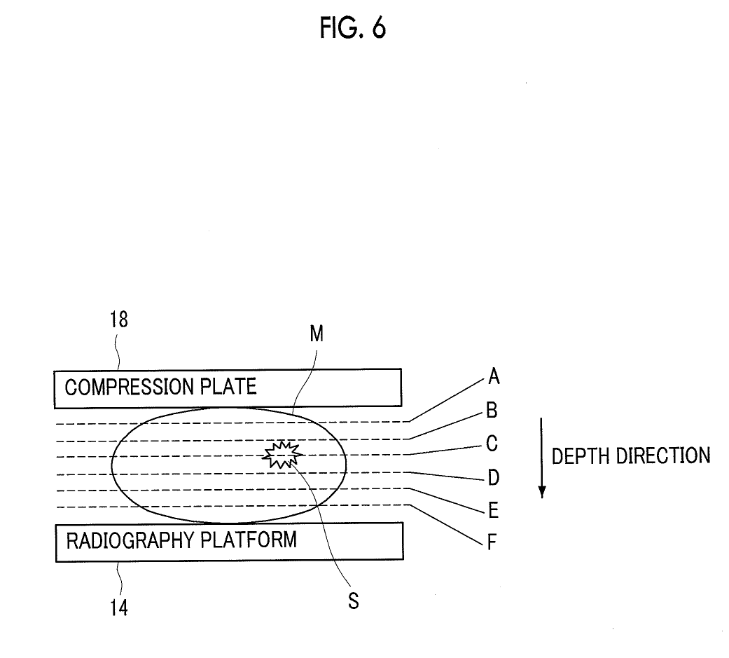

Specifically, for example, when the tomographic image signals A to F input to the combined tomographic image generation unit 41 are tomographic image signals of the breast M including calcification S shown in FIG. 6, a weighting factor n3 of a tomographic image signal C which is a tomographic image signal including the calcification S is set so as to be larger than the other weighting factors n1, n2, and n4 to n6. In addition, in the present embodiment, the weighting factors n1, n2, and n4 to n6 other than the weighting factor n3 are set so as to satisfy the relation of Expression (2) below according to the positions in the depth direction of the tomographic image signals A, B, and D to F shown in FIG. 6. That is, a smaller weighting factor is assigned as the position in the depth direction of the tomographic image signal is located on the deeper side.

n3>n1>n2>n4>n5>n6 (2)

Moreover, the combined tomographic image generation unit 41 generates the combined tomographic image signal G using the weighting factors set as described above and outputs the combined tomographic image signal G to the display control unit 8e. Here, the depth direction means the direction from the compression plate to the radiography platform as shown in FIG. 6, namely the direction away from the radiation irradiation unit.

The display control unit 8e performs predetermined processing on the input combined tomographic image signal, outputs the processed signal to the monitor 3 so as to display the combined tomographic image on the monitor 3. The combined tomographic image displayed on the monitor 3 is an image as observed from the upper side of the breast M shown in FIG. 6.

According to the breast image radiographing and displaying system of the embodiment described above, the combined tomographic images can be displayed in an easily viewable manner, and calcification or the like included in the target tomographic image can be understood immediately.

In the embodiment above, the weighting factors n1, n2, and n4 to n6 other than the weighting factor n3 have been set according to the positions in the depth direction of the corresponding tomographic image signals A, B, and D to F. However, the method of setting weighting factors is not limited to this, and for example, the weighting factors of tomographic image signals front and behind the target tomographic image, namely the tomographic image signals B and D may be set so as to be larger than the weighting factors of the tomographic image signals A, E, and F other than the tomographic images front and behind the target tomographic image. That is, the weighting factors may be set so as to satisfy the relation of Expression (3) below. In this case, the weighting factors n2 and n4 have values which decrease as the positions in the depth direction of the corresponding tomographic image signals are located on the deeper side. The same is applied to the weighting factors n1, n5, and n6.

n3>n2>n4>n1>n5>n6 (3)

By setting the weighting factors as described above, an image near the target tomographic image can be displayed even more emphatically.

The method of setting weighting factors is not limited to the above-described method. For example, when it is desired to observe the relationship between the target tomographic image and a tomographic image on the deeper side of the target tomographic image, in addition to setting the weighting factor n3 of the target tomographic image C to a large value as described above, and a weighting factor of at least one tomographic image of the tomographic images D, E, and F on the deeper side of the target tomographic image C may be set so as to be equal to the weighting factor n3. In this case, the weighting factors of the tomographic images A and B on the front side of the target tomographic image C are set so as to be smaller than the weighting factors of the target tomographic image C and the tomographic images D, E, and F on the deeper side of the target tomographic image C.

In contrast, for example, when it is desired to observe the relationship between the target tomographic image and a tomographic image on the front side of the target tomographic image, in addition to setting the weighting factor n3 of the target tomographic image C to a larger value as described above, a weighting factor of at least one tomographic image of the tomographic images A and B on the front side of the target tomographic image C may be set so as to be equal to the weighting factor n3. In this case, the weighting factors of the tomographic images D, E, and F on the deeper side of the target tomographic image C are set so as to be smaller than the weighting factors of the target tomographic image C and the tomographic images A and B on the front side of the target tomographic image C.

By setting the weighting factors in the above-described manner, the relationship between the target tomographic image and the tomographic image on the deeper side thereof and the relationship between the target tomographic image and the tomographic image on the front side thereof can be understood, and a larger amount of diagnostic information can be acquired.

Moreover, the weighting factors corresponding to tomographic images other than the target tomographic image may be set to zero.

In the embodiment described above, one tomographic image has been specified as the target tomographic image. However, the number of target tomographic images is not limited to this, and a plurality of tomographic images may be specified as the target tomographic images.

Moreover, in the embodiment described above, the combined tomographic image has been displayed on the monitor 3. However, the respective tomographic images based on the respective tomographic image signals may be displayed, and the combined tomographic images and the respective tomographic images may be displayed at the same time. Moreover, the display of the combined tomographic image and the display of the respective tomographic images may be switched according to a switching instruction from the input unit 4. Furthermore, when displaying the respective tomographic images as described above, an operator may designate a tomographic image being displayed using the input unit 4 as the target tomographic image.

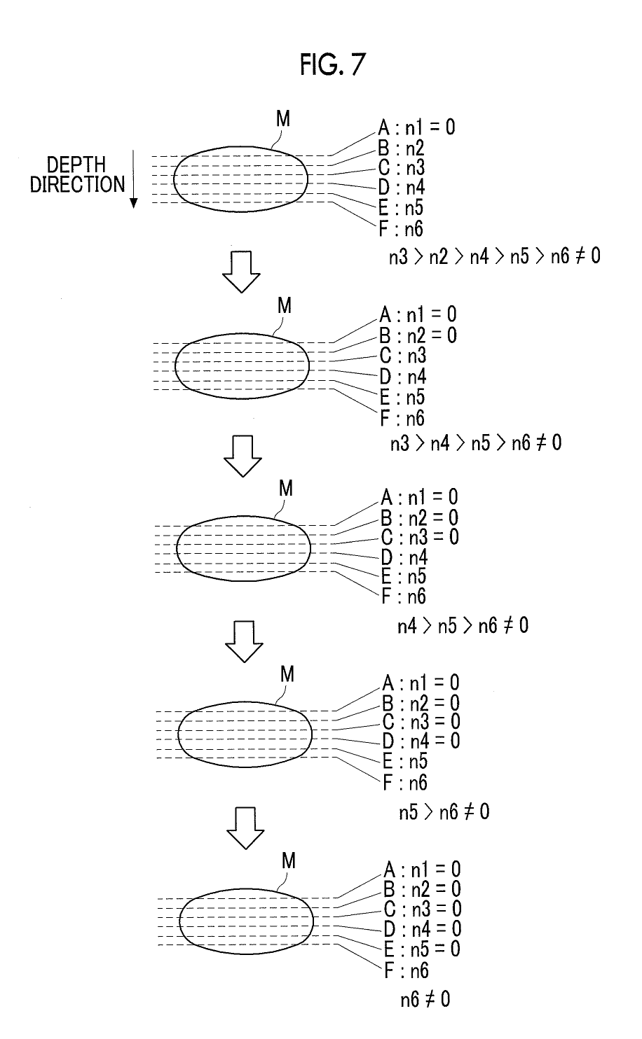

In the embodiment described above, the combined tomographic image has been generated and displayed by setting the weighting factors based on Expression (2). However, after the combined tomographic image is displayed on the monitor 3, the combined tomographic image generation unit 41 may accumulatively change the weighting factors of a plurality of tomographic images to zero, starting sequentially from the frontmost tomographic image A as shown in FIG. 7 to thereby generate sequentially combined tomographic images, in which a predetermined tomographic image on the deeper side of the frontmost tomographic image appears on the frontmost surface, and display the combined tomographic images on the display 3. The plurality of combined tomographic images generated in this way may be displayed at the same time and may be displayed sequentially in a switched manner. Here, “accumulatively changing weighting factors to zero” means that after changing the weighting factor of a front tomographic image to zero, when the weighting factor of a tomographic image on the deeper side thereof is changed to zero, the weighting factor of the front tomographic image is maintained to be zero.

By accumulatively and sequentially changing the weighting factors of tomographic images to zero in the above-described manner, the tomographic image B appears on the frontmost surface in the first combined tomographic image in FIG. 7, the tomographic image C appears on the frontmost surface in the second combined tomographic image, the tomographic image D appears on the frontmost surface in the third combined tomographic image, the tomographic image E appears on the frontmost surface in the fourth combined tomographic image, and the tomographic image F appears on the frontmost surface in the fifth combined tomographic image. The weighting factors other than the weighting factor set to zero have the magnitude relationship as shown in FIG. 7.

When the weighting factors are set in the above-described manner, for example, by successively displaying the plurality of combined tomographic images in a switched manner, the combined tomographic images can be observed while enabling viewers to understand the spatial distribution of a region of interest such as calcification.

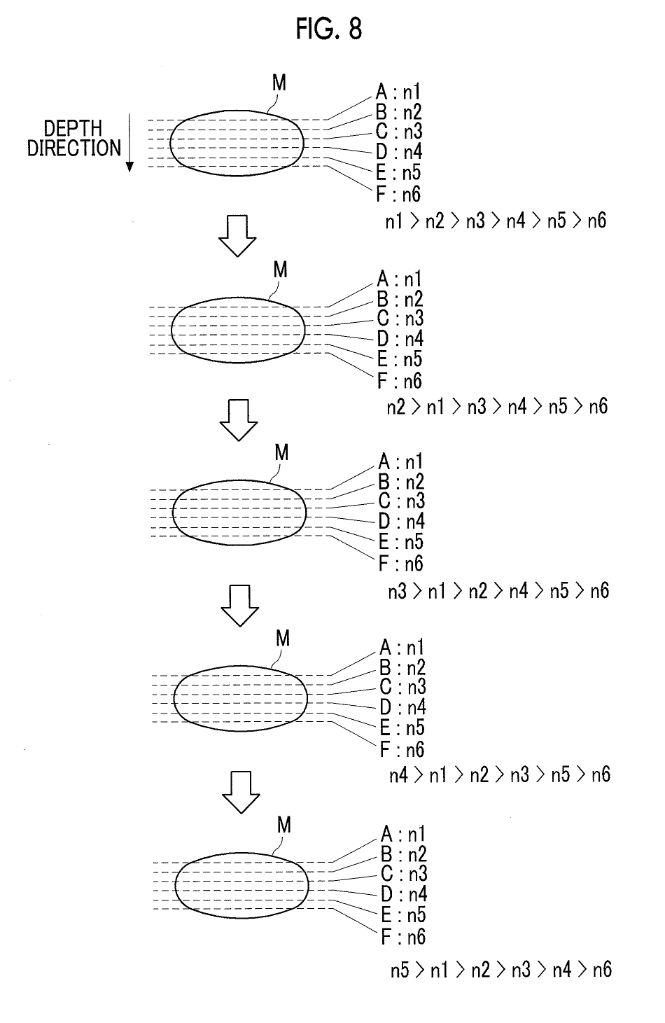

The combined tomographic image generation unit 41 may increase the weighting factors of a plurality of tomographic images so as to be larger than those of the other tomographic images, starting sequentially from the frontmost tomographic image as shown in FIG. 8 to thereby generate a plurality of combined tomographic images in which the respective tomographic images appear sharper. The plurality of combined tomographic images generated in this way may be displayed at the same time and may be displayed sequentially in a switched manner.

By increasing the weighting factors of tomographic images sequentially from the frontmost tomographic image in the above-described manner, the tomographic image A appears sharper in the first combined tomographic image in FIG. 8, the tomographic image B appears sharper in the second combined tomographic image, the tomographic image C appears sharper in the third combined tomographic image, the tomographic image D appears sharper in the fourth combined tomographic image, and the tomographic image E appears sharper in the fifth combined tomographic image. The weighting factors other than the weighting factor set to the largest value have the magnitude relationship as shown in FIG. 8.

While various methods of setting the weighting factors multiplied to the tomographic images have been described, these respective setting methods may be set in advance as weighting factor setting modes, and the operator may select and designate one from the setting modes as necessary.

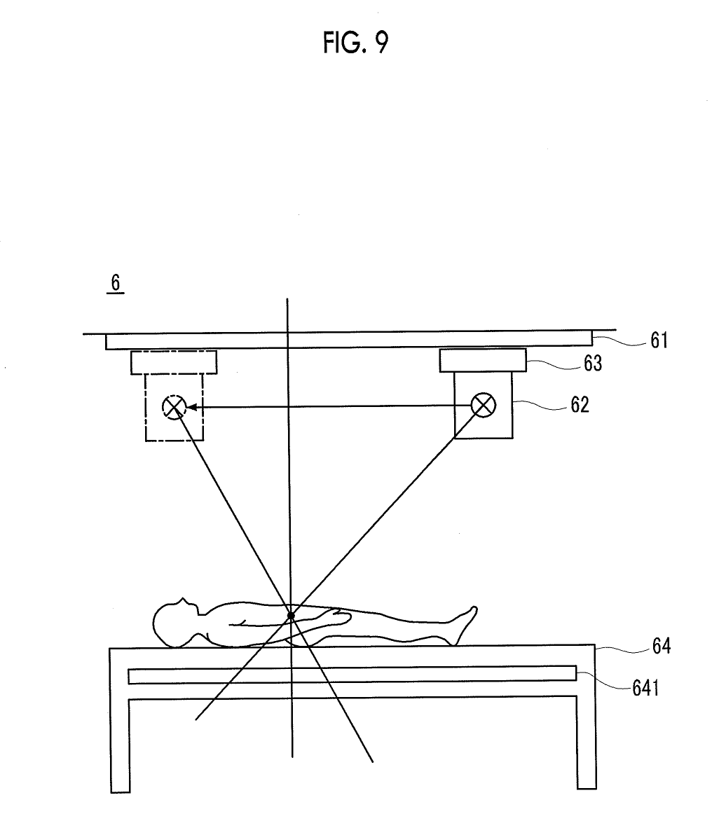

In the embodiment above, although an embodiment of the tomographic image displaying apparatus of the present invention has been applied to the breast image radiographing and displaying system, a subject of the present invention is not limited to a breast. For example, the present invention can be applied to a radiological image radiographing and displaying system having a so-called tomosynthesis imaging function for general radiography which radiographs the chest, the head, and the like. FIG. 9 shows a simplified configuration of the radiological image radiographing and displaying system 6. The computer, the monitor, and the input unit are the same as those of the embodiment described above, and illustration thereof is not provided.

The radiological image radiographing and displaying system 6 includes a rail 61 arranged on the ceiling of a consultation room or an examination room, a radiation irradiation unit 63 that is attached to the rail 61 so as to be movable along the rail 61, and a radiography platform 64. A radiation source 62 is contained in the radiation irradiation unit 63. Moreover, a radiological image detector 641 is provided inside the radiography platform 64.

The radiological image radiographing and displaying system 6 shown in FIG. 9 is different from that of the above embodiment in that the radiation source 62 moves along a straight line rather than a circular arc. However, the incidence angle of radiation changes depending on the position of the radiation source similarly to that of the above embodiment.

In the radiological image radiographing and displaying system 6 shown in FIG. 9, similarly to the above embodiment, when the radiation irradiation unit 63 is moved, a plurality of radiological images is acquired, a plurality of tomographic images is generated based on the plurality of radiological images, and a combined tomographic image is generated and displayed based on the plurality of tomographic images.

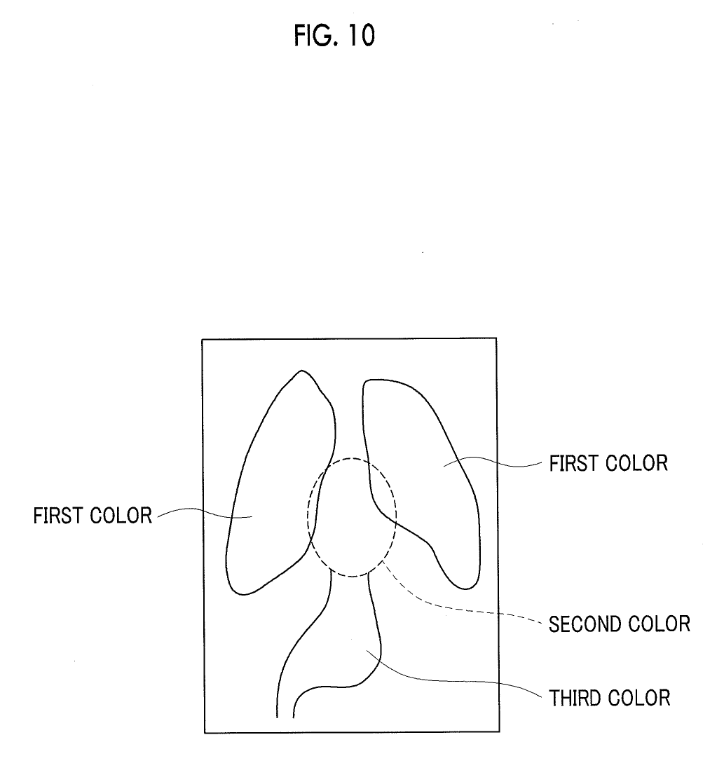

In the combined tomographic image generated by the radiological image radiographing and displaying system 6 described above, the tissues of lung, heart, or stomach, for example, are colored using first to third colors as shown in FIG. 10. Moreover, the color gradations of the respective tissues in the combined tomographic image may be changed by setting the magnitudes of the weighting factors of the respective tomographic images constituting the combined tomographic image of the respective tissues. Specifically, the weighting factors may be set so that the color of the tomographic image becomes denser as it advances into the deeper side.

In the above embodiment, an embodiment of the tomographic image displaying apparatus of the present invention has been applied to the breast image radiographing and displaying system and the radiological image radiographing and displaying system having the tomosynthesis imaging function. However, the tomographic image displaying apparatus of the present invention can be applied to a so-called CT (Computed Tomography) radiographing apparatus, and a combined tomographic image may be generated similarly to the above embodiment using a plurality of tomographic images acquired by the CT radiographing apparatus.

What is claimed is:

1. A tomographic image displaying method comprising:
irradiating a subject with radioactive rays from a plurality of different radiographing directions;
acquiring a radiological image for each of the radiographing directions, detected by a radiological image detector with the irradiation of radioactive rays;
generating a plurality of tomographic images of the subject based on a plurality of acquired radiological images; and
displaying the plurality of generated tomographic images, the method further comprising:
specifying a predetermined target tomographic image among the plurality of tomographic images;
multiplying a weighting factor to each of the plurality of tomographic images and adding the plurality of tomographic images multiplied by the weighting factors to thereby generate a combined tomographic image; and
displaying the generated combined tomographic image,
wherein a weighting factor multiplied to the specified target tomographic image is set so as to be larger than a weighting factor multiplied to at least one tomographic image other than the target tomographic image.

2. A tomographic image displaying apparatus comprising:
a radiological image acquisition unit that irradiates a subject with radioactive rays from a plurality of different radiographing directions to acquire a radiological image for each of the radiographing directions, detected by a radiological image detector with the irradiation of radioactive rays;
a tomographic image generation unit that generates a plurality of tomographic images of the subject based on a plurality of radiological images acquired by the radiological image acquisition unit; and
a display unit that displays the plurality of tomographic images generated by the tomographic image generation unit, the apparatus further comprising:
a combined tomographic image generation unit that multiplies a weighting factor to each of the plurality of tomographic images generated by the tomographic image generation unit and adds the plurality of tomographic images multiplied by the weighting factors to thereby generate a combined tomographic image; and
a target tomographic image specifying unit that specifies a predetermined target tomographic image among the plurality of tomographic images,
wherein the combined tomographic image generation unit sets a weighting factor of the target tomographic image specified by the target tomographic image specifying unit so as to be larger than a weighting factor of at least one tomographic image other than the target tomographic image, and
wherein the display unit displays the combined tomographic image generated by the combined tomographic image generation unit.

3. The tomographic image displaying apparatus according to claim 2,
wherein the combined tomographic image generation unit sets the weighting factor of the target tomographic image to the largest value.

4. The tomographic image displaying apparatus according to claim 3,
wherein the combined tomographic image generation unit sets weighting factors of tomographic images front and behind the target tomographic image so as to be smaller than that of the target tomographic image and larger than the weighting factors of tomographic images other than the tomographic images front and behind the target tomographic image.

5. The tomographic image displaying apparatus according to claim 4,
wherein the combined tomographic image generation unit multiplies a weighting factor to tomographic images other than the target tomographic image and the tomographic images front and behind the target tomographic image according to the depths of the tomographic images.

6. The tomographic image displaying apparatus according to claim 2,
wherein the combined tomographic image generation unit sets the weighting factors of the target tomographic image and tomographic images on the behind side of the target tomographic image so as to be larger than the weighting factors of the other tomographic images.

7. The tomographic image displaying apparatus according to claim 2,
wherein the combined tomographic image generation unit sets the weighting factors of the target tomographic image and tomographic images on the front side of the target tomographic image so as to be larger than the weighting factors of the other tomographic images.

8. The tomographic image displaying apparatus according to claim 2,
wherein the combined tomographic image generation unit sets the weighting factors of tomographic images other than the target tomographic image to zero.

9. The tomographic image displaying apparatus according to claim 2,
wherein the combined tomographic image generation unit accumulatively changes the weighting factors of the plurality of tomographic images to zero sequentially starting from the frontmost tomographic image to thereby generate a plurality of combined tomographic images in which a predetermined tomographic image on the deeper side of the frontmost tomographic image appears on the frontmost surface.

10. The tomographic image displaying apparatus according to claim 3,
wherein the combined tomographic image generation unit accumulatively changes the weighting factors of the plurality of tomographic images to zero sequentially starting from the frontmost tomographic image to thereby generate a plurality of combined tomographic images in which a predetermined tomographic image on the deeper side of the frontmost tomographic image appears on the frontmost surface.

11. The tomographic image displaying apparatus according to claim 4,
wherein the combined tomographic image generation unit accumulatively changes the weighting factors of the plurality of tomographic images to zero sequentially starting from the frontmost tomographic image to thereby generate a plurality of combined tomographic images in which a predetermined tomographic image on the deeper side of the frontmost tomographic image appears on the frontmost surface.

12. The tomographic image displaying apparatus according to claim 5,
wherein the combined tomographic image generation unit accumulatively changes the weighting factors of the plurality of tomographic images to zero sequentially starting from the frontmost tomographic image to thereby generate a plurality of combined tomographic images in which a predetermined tomographic image on the deeper side of the frontmost tomographic image appears on the frontmost surface.

13. The tomographic image displaying apparatus according to claim 6,
wherein the combined tomographic image generation unit accumulatively changes the weighting factors of the plurality of tomographic images to zero sequentially starting from the frontmost tomographic image to thereby generate a plurality of combined tomographic images in which a predetermined tomographic image on the deeper side of the frontmost tomographic image appears on the frontmost surface.

14. The tomographic image displaying apparatus according to claim 7,
wherein the combined tomographic image generation unit accumulatively changes the weighting factors of the plurality of tomographic images to zero sequentially starting from the frontmost tomographic image to thereby generate a plurality of combined tomographic images in which a predetermined tomographic image on the deeper side of the frontmost tomographic image appears on the frontmost surface.

15. The tomographic image displaying apparatus according to claim 8,
wherein the combined tomographic image generation unit accumulatively changes the weighting factors of the plurality of tomographic images to zero sequentially starting from the frontmost tomographic image to thereby generate a plurality of combined tomographic images in which a predetermined tomographic image on the deeper side of the frontmost tomographic image appears on the frontmost surface.
